(19) United States
(12) Patent Application Publication
(10) Pub. No.: US 2005/0195785 A1
(43) Pub. Date: Sep. 8, 2005

(54) Image signal processing device

(75) Inventors: Mitsuhiro Matsumoto, Tokyo (JP); Eiichi Ito, Tokyo (JP); Koji Tsuda, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/072,461

(22) Filed: Mar. 7, 2005

(30) Foreign Application Priority Data
Mar. 8, 2004 (JP) 2004-063650

(51) Int. Cl. H04Q 7/24

(52) U.S. Cl. 370/338

(57) ABSTRACT

An image signal processing device for processing an image signal transmitted from an imaging unit by radio is provided. The image signal processing device is provided with at least one antenna that receives the image signal transmitted from the imaging unit by radio, a substrate, and a plurality of 2D-DST elements arranged on the substrate. The plurality of 2D-DST elements include a plurality of receiving elements each of which includes a processing unit having functions of receiving the image signal and processing the received image signal. The plurality of receiving elements are connected to the at least one antenna. At least a part of the plurality of receiving elements contributes to time-division multiplexing of receiving the image signal and processing the image signal.

### BACKGROUND OF THE INVENTION

The present invention relates to an image signal processing device in accordance with a two-dimensional diffusive signal transmission technology using a plurality of communication elements.

The two-dimensional diffusive signal transmission (2D-DST) technology is disclosed in Japanese Patent Provisional Publication P2003-188882A. In the above publication, disclosed is a communication device which is provided with a plurality of diffusively arranged communication elements. Each communication element has a function to communicate only with surrounding communication elements. Each communication element is configured such that the communication distance is sufficient for a local communication, i.e., sufficient so that it can communicate with other communication elements surrounding the element. By sequentially performing the local communications, a signal is transmitted sequentially through the plurality of communication elements. In particular, the plurality of communication elements has a hierarchic arrangement and transmission path is set for each hierarchic structure, thereby signals can be transmitted to a final destination efficiently.

### SUMMARY OF THE INVENTION

As one exemplary application, the 2D-DST technology can be applied to an image signal processing device. For example, a radio image signal transmitted from a capsule endoscope may be received by signal receiving elements arranged on a 2D-DST substrate. Predetermined signal processing operations are applied to the received image signal, and the processed signal is transmitted in accordance with the 2D-DST technology. When the image signal is processed/transmitted, the following operations are executed by the 2D-DST elements connected to a signal receiving antenna. The operations performed by the 2D-DST elements include amplification of the received signal, an A/D (analogue-to-digital) conversion, compensation, compression, signal analysis, generation of transmission signals to be transmitted to another 2D-DST element. If a large amount of image signal is processed by a single 2D-DST element, a burden to the 2D-DST element becomes very large. Thus, according to a conventional technology, in order to process an image signal, large-scale, high-performance and relatively expensive 2D-DST elements should be used.

The present invention is advantageous in that the burden to each 2D-DST element for processing an image signal is reduced, the image signal being thereby processed and transmitted by use of small and inexpensive elements.

According to an aspect of the invention, there is provided an image signal processing device for processing an image signal transmitted from an imaging unit by radio. The image signal processing device is provided with at least one antenna that receives the image signal transmitted from the imaging unit by radio, a substrate, and a plurality of 2D-DST elements arranged on the substrate. The plurality of 2D-DST elements include a plurality of receiving elements each of which includes a processing unit having functions of receiving the image signal and processing the received image signal. The plurality of receiving elements are connected to the at least one antenna. At least a part of the plurality of receiving elements contributes to time-division multiplexing of receiving the image signal and processing the image signal.

Since the receiving of the image signal and the processing of the received image data is conducted by time-division multiplexing, a burden on each 2D-DST element is reduced. Therefore, it becomes possible to configure the image signal processing device using a small-sized and inexpensive receiving element.

Optionally, the plurality of 2D-DST elements may include a plurality of relaying elements each of which has a function of relaying data processed by the at least a part of the plurality of receiving elements.

Still optionally, the signal processing device may include a control unit capable of receiving data from all of the plurality of 2D-DST elements to measure intensity distribution of intensities of the image signal received by the plurality of the receiving elements. The at least a part of the plurality of receiving elements contributing to the time-division multiplexing may be selected by the control unit from the plurality of receiving elements based on the intensity distribution.

In a particular case, the at least one antenna may include a plurality of antennas, and the plurality of antennas may be connected to the plurality of receiving elements, respectively.

Optionally, the at least a part of the plurality of receiving elements selected by the control unit may include a first receiving element having a highest receiving intensity of the image signal, and at least one second receiving element surrounding the first receiving element.

Alternatively, the at least a part of the plurality of receiving elements selected by the control unit may include a first receiving element having a highest receiving intensity of the image signal, and at least one second receiving element capable of directly communicating with the first receiving element.

Still optionally, the at least a part of the plurality of receiving elements selected by the control unit may include at least two receiving elements having receiving intensities of the image signal larger than a predetermined level.

Still optionally, the control unit may divide the plurality of receiving elements into a plurality of groups and selects one of the plurality of groups having a highest average receiving intensity of all of the plurality of groups. In this case, the at least a part of the plurality of receiving elements contributing to the time-division may include receiving elements belonging to the selected one of the plurality of groups.

Still optionally, the control unit may divide the plurality of receiving elements into a plurality of groups and selects first groups from the plurality of groups, receiving intensities of receiving elements belonging to the first groups are larger than a predetermined level, and the control unit may further select one of the first groups having a smallest intensity variation of all of the first group. In this case, the at least a part of the plurality of receiving elements contributing to the time-division includes receiving elements belonging to the selected one of the first groups.

In a particular case, the at least one antenna may include a plurality of antennas, and each of the plurality of antennas may be connected to two or more of the plurality of receiving elements.

Optionally, the at least a part of the plurality of receiving elements contributing to the time-division may include receiving elements connected to one of the plurality of antennas having a highest receiving intensity.

Alternatively, the at least a part of the plurality of receiving elements contributing to the time-division may include receiving elements connected to one of the plurality of antennas having a receiving intensity larger than a predetermined level.

Still optionally, each of the plurality of receiving elements may include a communication unit having a function of sending processed data processed by the processing unit to one of the plurality of relaying elements. In this case, the time-division multiplexing conducted by the at least a part of the plurality of receiving elements may further include sending the processed data to one of the plurality of relaying elements.

Still optionally, the at least a part of the plurality of receiving elements contributing to the time-division multiplexing may perform the receiving of the image signal, the processing of the image signal, and the sending of the processed data in this order.

Still optionally, the image signal transmitted by the imaging unit may include synchronizing signals, and the time-division multiplexing of receiving the image signal and processing the image signal may be conducted in synchronization with the synchronizing signals included in the image signal.

In a particular case, the at least a part of the plurality of receiving elements contributing to the time-division multiplexing may count the synchronizing signals included in the image signal to start the receiving of the image signal based on a count of the synchronizing signals.

In a particular case, the plurality of 2D-DST elements may include a plurality of relaying elements each of which has a function of relaying data processed by the at least a part of the plurality of receiving elements, and one of the plurality of relaying elements may generate an enabling signal indicating permission of reception of the image signal. In this case, the at least a part of the plurality of receiving elements contributing to the time-division multiplexing starts the receiving of the image signal based on the enabling signal generated by the one of the plurality of relaying elements.

In a particular case, the at least a part of the plurality of receiving elements contributing to the time-division multiplexing may include two or more receiving elements. In this case, a first receiving element of the two or more receiving elements contributing to the time-division multiplexing outputs a completion signal after finishing the receiving of the image signal, and a second receiving element of the two or more receiving elements contributing to the time-division multiplexing starts the receiving of the image signal based on the completion signal outputted by the first receiving element.

In a particular case, the first receiving element may be capable of directly communicating with the second receiving element.

According to another aspect of the invention, there is provided an image signal processing device, which is provided with a capsule endoscope having an imaging unit which captures an image and transmits an image signal of the image by radio, at least one antenna that receives the image signal transmitted from the imaging unit, a substrate, and a plurality of 2D-DST elements arranged on the substrate. In this structure, the plurality of 2D-DST elements include a plurality of receiving elements each of which includes a processing unit having functions of receiving the image signal and processing the received image signal. The plurality of receiving elements are connected to the at least one antenna. At least a part of the plurality of receiving elements contributes to time-division multiplexing of receiving the image signal and processing the image signal.

Since the receiving of the image signal and the processing of the received image data is conducted by time-division multiplexing, a burden on each 2D-DST element is reduced. Therefore, it becomes possible to configure the image signal processing device using a small-sized and inexpensive receiving element.

### BRIEF DESCRIPTION OF THE ACCOMPANYING DRAWINGS

FIG. 1 shows a perspective view of a 2D-DST circuit board;

FIG. 2 is a block diagram showing a 2D-DST circuit that receives an image signal of an endoscope;

FIG. 3A schematically shows a cross-sectional side view of the 2D-DST circuit shown in FIG. 2;

FIG. 3B is a block diagram of an image receiving unit;

FIG. 3C is a plan view of the 2D-DST circuit shown in FIG. 3A;

FIG. 4A is a cross-sectional side view of another 2D-DST in which a plurality of receiving elements are connected to a single antenna;

FIG. 4B is a block diagram of an image receiving unit;

FIG. 4C is a plan view of the 2D-DST circuit shown in FIG. 4A;

FIGS. 5-7 show a method to select receiving elements;

FIG. 8 shows a signal flow of the 2D-DST circuit shown in FIGS. 4A-4C when a plurality of receiving elements receive the image signal;

FIG. 9 shows a signal flow of the 2D-DST circuit shown in FIGS. 3A-3C where a plurality of 2D-DST elements are connected to a single antenna;

FIG. 10 shows a timing diagram illustrating operation of the receiving elements S and relaying elements T processing the image signal;

FIG. 11 is a flowchart illustrating an operation from a signal reception setting to start of signal reception by the 2D-DST circuit;

FIG. 12A is a flowchart illustrating an image signal receiving operation executed by the receiving elements;

FIG. 12B is a flowchart illustrating an image signal receiving operation executed by the relaying element;

FIG. 13 shows a timing diagram showing an operation of the receiving elements and relaying element when the relaying element issues an allowance to start receiving the image signal;

FIG. 14A is a flowchart illustrating an image receiving operation executed by the receiving element;

FIG. 14B is a flowchart illustrating an operation executed by the relaying element;

FIG. 15 is a timing diagram illustrating the operation of the receiving elements that processing the image signal and relaying element;

FIG. 16A is a flowchart illustrating an image receiving operation executed by the receiving elements; and

FIG. 16B is a flowchart illustrating an operation executed by the relaying element.

### DETAILED DESCRIPTION OF THE EMBODIMENT

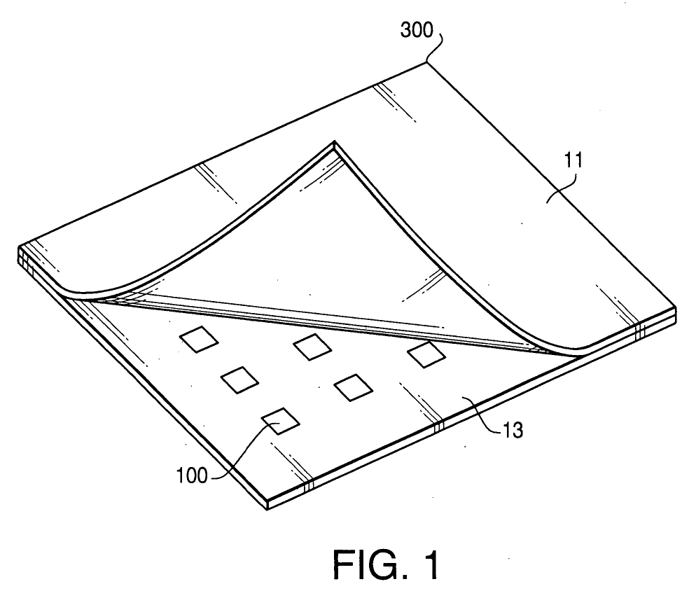

FIG. 1 is a perspective view of a 2D-DST circuit 300. The 2D-DST circuit 300 has a conductive layer 11, a conductive layer 13 and a plurality of 2D-DST elements 100. In this example shown in FIG. 1, the 2D-DST elements 100 are nipped between two conductive layers 11 and 13, which are made of flexible material. The conductive layer 11 and the conductive layer 13 function as a substrate for the 2D-DST elements 100. Each 2D-DST element is thus connected with the two conductive layers 11 and 13. Each of the conductive layers 11 and 13 is composed of a single layer or a plurality of layers. In this example, each layer has a single layer structure. In FIG. 1, in order to show that the 2D-DST elements 100 are nipped between the layers 11 and 13, a part of the layer 11 is curled up, which is normally extended.

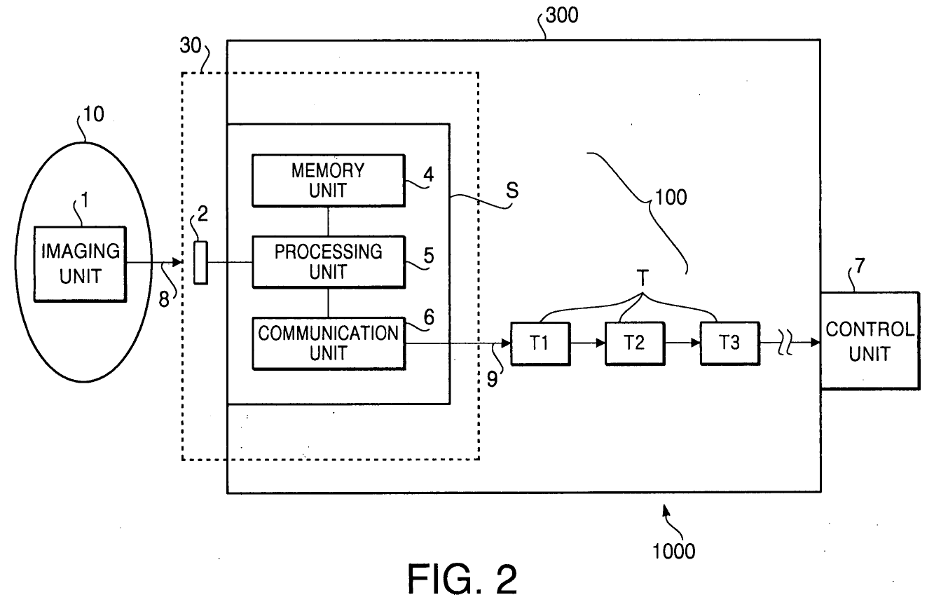

FIG. 2 is a block diagram showing an endoscope system 1000 including a capsule endoscope 10, and the 2D-DST circuit 300. The 2D-DST circuit 300 receives the image signal of the capsule endoscope 10. In FIG. 2, an antenna 2 and control unit 7, which are not shown in FIG. 1, are shown. The capsule endoscope 10 has an imaging unit 1 that captures an image of an object to be observed. The 2D-DST circuit 300 includes an image signal receiving unit 30, relaying elements T (T1, T2, T3) and the control unit 7. The 2D-DST elements 100 can be divided into receiving elements S and relaying elements T. The image signal receiving unit 30 includes the antenna 2 and the receiving elements S. Further, as shown in FIG. 2, the receiving element S includes a memory unit 4, a processing unit 5 and a communication unit 6.

The imaging unit 1 captures an image of the object, and transmits an image signal 8 representing the capture image by radio. The transmitted image signal 8 is received by the antenna 2. In this example, the antenna 2 is connected to the processing unit 5. Alternatively or optionally, the antenna may be built in a receiving element S. Further, according to the embodiment, the image data is transmitted by radio and is received by the antenna 2. The invention need not be limited to this configuration, and the image data may be transmitted through a cable.

The image signal 8 is processed by the processing unit 5, and then transmitted from the communication unit 6. The processed data 9 output by the communication unit 6 is relayed and transmitted by the relaying elements T to the control unit 7, which can communicate with 2D-DST elements 100 located close to the control unit in accordance with the 2D-DST technology. The control unit 7 also functions as a power source for the 2D-DST elements 100, a data storage for control programs and image data, and an interface that interfaces signal output to an external device. For example, the control unit 7 can be connected to an external personal computer with or without wires and transmit a video signal.

Next, the memory unit 4, the communication unit 6 and the processing unit 5 will be described. The memory unit 4 stores, in advance or when necessary, information necessary for realizing a communication function and other functions. The communication unit 6 exchanges signals with other 2D-DST elements. The processing unit 5 processes the image signal. The processing unit 5 also controls the communication among the 2D-DST elements. Preferably, the processing unit 5 executes operations related to the signal transmission among the 2D-DST elements such as monitoring the signals around the 2D-DST element, analysis of the received signal, generation of a transmission signal and control of signal transmission. Further, the processing unit 5 may optionally operate to realize functions other than the communicating function such as a sensor function and calculating function.

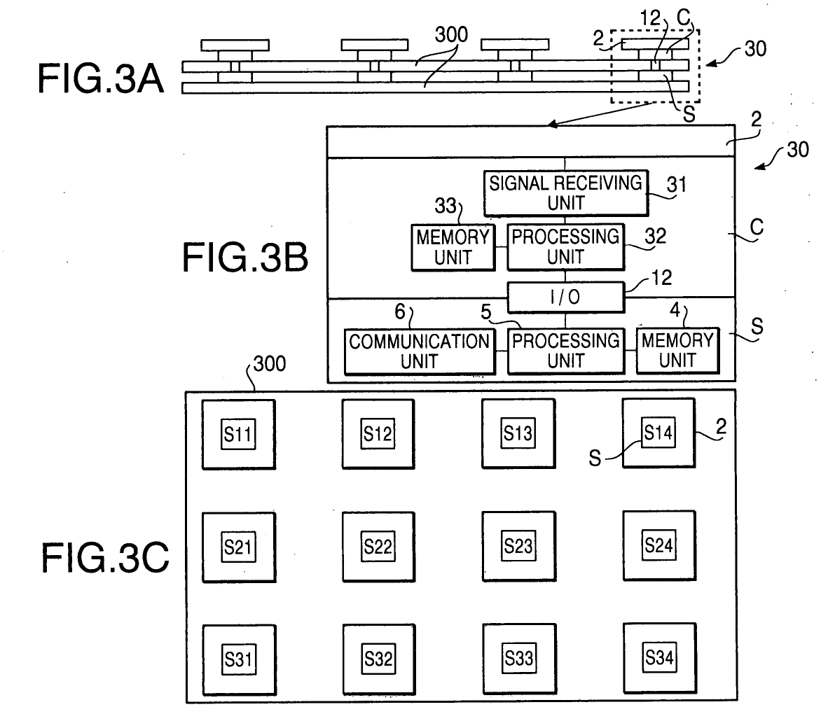

FIG. 3A is a cross-sectional view of a part of 2D-DST circuit 300. In FIG. 3A, a sensor module C and I/O unit 12, which are not shown in FIGS. 1 and 2, are shown. The image signal receiving unit 30 includes the antenna 2, sensor module C and receiving elements S, and the receiving elements S includes the I/O unit 12 which interfaces the connection with the sensor module C. The receiving elements S are nipped between the layers of the 2D-DST circuit 300 and connected with the sensor module C via the I/O unit 12. In this embodiment, the antenna is arranged externally. Alternatively, it is possible that the antenna 2 is built in the sensor module C.

FIG. 3B shows the image signal receiving unit 30 and illustrates functional blocks thereof. The sensor module C includes a signal receiving unit 31, processing unit 32 and memory unit 33, which are not shown in FIG. 3A. Each receiving element S has the memory unit 4, processing unit 5, communication unit 6 and I/O unit 12. The image signal received by the antenna 2 is transmitted to the processing unit 5 of the receiving element S via the signal receiving unit 31, processing unit 32 and I/O unit 12 in this order. It should be noted that, in this embodiment, the antenna 2 and the receiving element S are connected via the sensor module C. However, this configuration can be modified such that a receiving element including the sensor function is connected with an antenna. Further, in the embodiment, an antenna is connected to the sensor module. This can be modified such that another sensor is connected with the sensor module depending on its usage.

FIG. 3C is a plan view of the 2D-DST circuit 300 shown in FIG. 3A. A single sensor module C connected with a single antenna 2 is connected with a single receiving element S. As described above, there is a sensor module C between the antenna 2 and the receiving element S. In FIG. 3C, the sensor module C is not shown for the brevity.

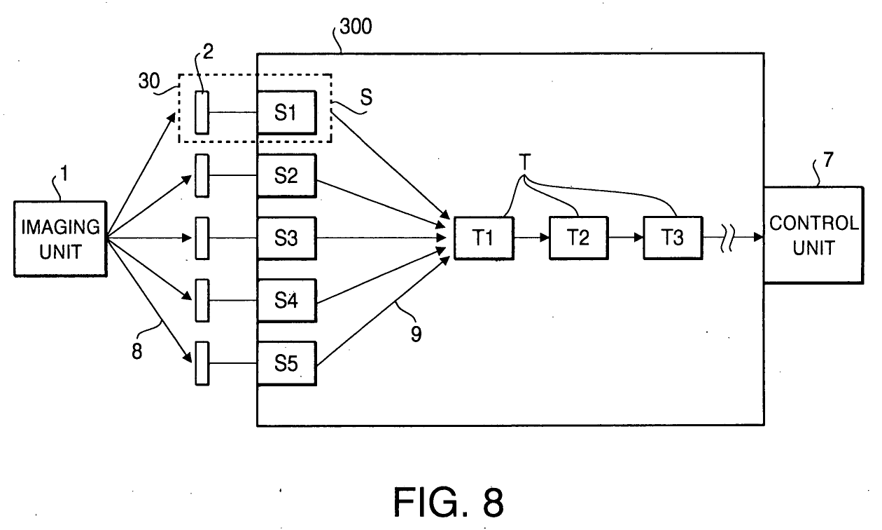

FIG. 8 shows an example of a configuration of the 2D-DST circuit 300 in which an image signal is received by a plurality of image signal receiving units 30. In FIG. 8, each receiving unit 30 includes the antenna 2, receiving element S and not-shown sensor module C.

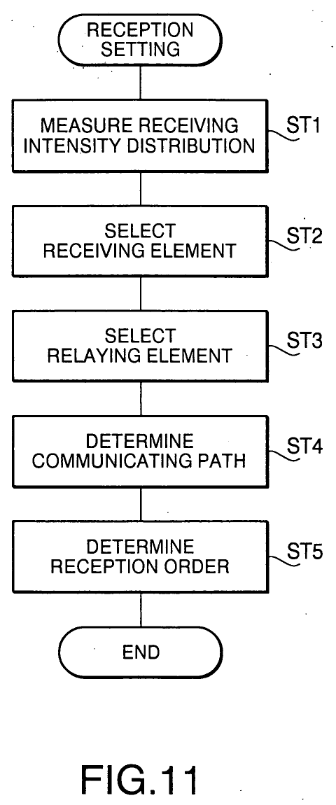

FIG. 11 is a flowchart illustrating a reception setting process executed under control of the control unit 7. The reception setting process is executed as a preparation for an image signal receiving process. Before the reception setting process is started, a selection rule of receiving elements (including the number of receiving elements contributing to the image signal receiving process) is determined.

Firstly, the intensity distribution of an image signal on the 2D-DST circuit 300 is measured (step ST1). More specifically, in step ST1, the image signal 8 from the imaging unit 1 is received by all of the receiving elements S and processed signals of all the receiving elements S are sent to the control unit 7 to measure the intensity distribution of the image signal on the 2D-DST circuit 300.

Next, in step ST2, two or more receiving elements contributing to the image signal receiving process are determined based on the intensity distribution measured in step ST1. Next, in step ST3, elements serving as relaying elements T are determined. More specifically, at least one relaying elements T which is capable of directly communicating with the selected receiving elements are determined. The term “communicate directly with” or “direct communication” as used herein means communication between first-order communication elements or communication in which a third-order communication element transmits data to communication elements located within its communication range, as disclosed in the publication P2003-188882A.

Next, the shortest path between the selected relaying element T and the control unit 7 is determined in step ST4. A scheme for determining a shortest path disclosed in the publication P2003-188882A may be employed to determine the shortest path in step ST4.

In this embodiment, the image signal receiving process is conducted by time-division multiplexing using the selected receiving elements (i.e. receiving elements S1, S2, S3, S4, and S5 in the example of FIG. 8). In step ST5, the order in which the receiving elements receive the image signal (i.e. the order of time-division multiplexing) is determined. The time-division multiplexing of the image signal receiving process may be conducted on a field-by-field basis or on a line-by-line basis. The processed data 9 is transmitted to the control unit 7 via the relaying elements T (i.e. relaying elements T1, T2, T3, . . . in the example of FIG. 8). The time-division multiplexing of the image signal receiving process is conducted such that one receiving element receives the image signal while another receiving element processes the received image signal or sends the processed data.

Since time-division multiplexing of the image signal receiving process (i.e. time-division multiplexing of receiving the image signal 8, processing the image signal 8, and sending the processed data 9) is conducted by a plurality of receiving elements S, a burden on each receiving element is reduced, and thereby it becomes possible to configure the 2D-DST circuit using a small-sized and inexpensive receiving element.

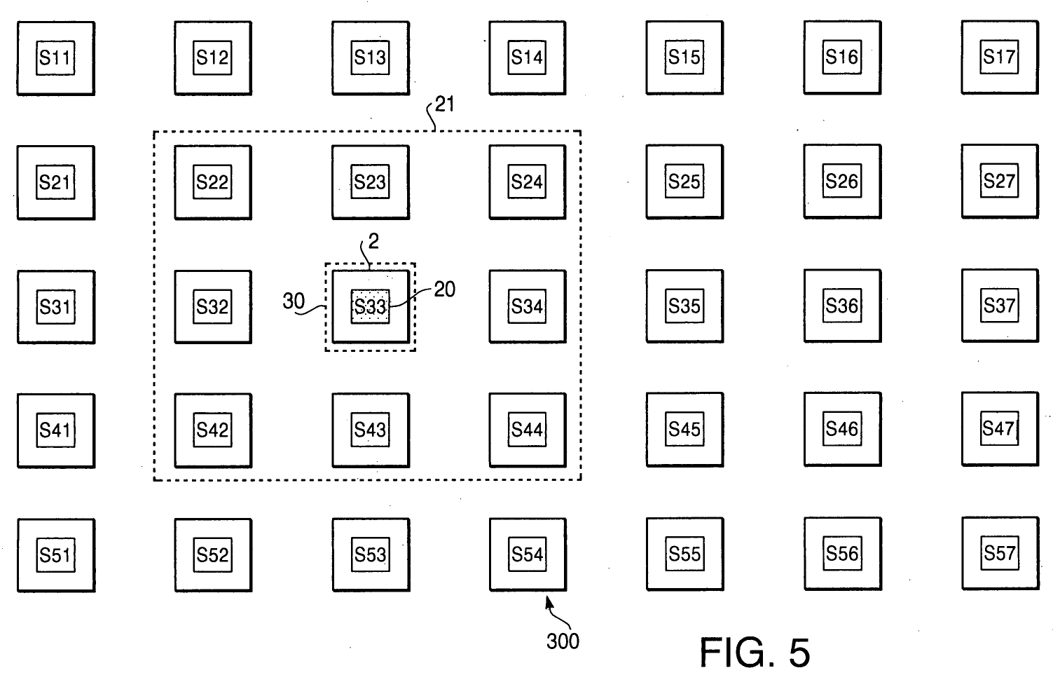

Next, a selection rule for selecting receiving elements used in the selection process in ST2 is explained with reference to FIG. 5. FIG. 5 is an explanatory diagram illustrating an example of a selection rule. As shown in FIG. 5, a plurality of receiving elements S (S1, S2, . . . , S57) are arranged in a matrix in the 2D-DST circuit 300. A receiving element assigned a reference number 20 (hereafter, referred to as a receiving element 20) has the highest receiving intensity (i.e. an antenna 2 of the receiving element 20 has the highest receiving intensity). All of the receiving elements S receive the image signal, and the receiving intensities of the image signal 8 detected by all of the receiving elements S are gathered by the control unit 7 (step S1 in FIG. 11). By analyzing the receiving intensities of all of the receiving elements S, the control unit 7 determines a receiving element having the highest receiving intensity (i.e. the receiving element 20).

Next, a predetermined number of receiving elements contributing to the image signal receiving process (i.e. the time-division multiplexing) are selected among receiving elements surrounding the receiving element 20. The 2D-DST circuit 300 may be configured such that a user can set the selection rule (e.g. the number of receiving elements conducting the time-division multiplexing). For example, receiving elements contributing to the image signal receiving process may be selected based on the order of receiving intensity among receiving elements surrounding the receiving element 20. For example, receiving elements within a region 21 may be selected in accordance with a selection rule.

By selecting receiving elements contributing to the image signal receiving process as described above, it is possible to receive the image signal 8 using a plurality of elements including a receiving element having the highest receiving intensity.

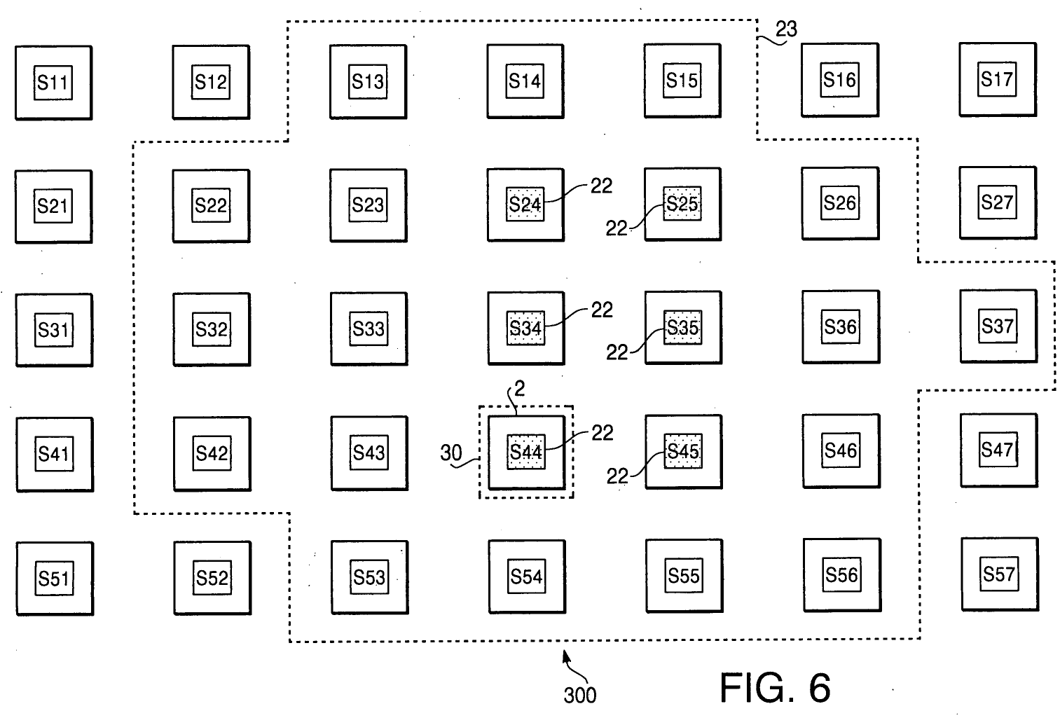

Next, another selection rule for selecting receiving elements used in the selection process in step ST2 is explained with reference to FIG. 6. FIG. 6 is an explanatory diagram illustrating an example of a selection rule. As shown in FIG. 6, a plurality of receiving elements S (S1, S2, . . . , S57) are arranged in a matrix in the 2D-DST circuit 300. In this example, a plurality of receiving elements having a receiving intensity larger than a certain level are selected by the control unit 7. Next, a predetermined number of receiving elements that contribute to the image signal receiving process are selected among the receiving elements having the receiving intensity larger than the certain level. Assuming that receiving elements within a region 23 have an intensity larger than the certain level, if it is known that the capsule endoscope 10 is situated at a left side in FIG. 6, receiving elements located on the left side within the region 23 (e.g. receiving elements S22, S32 and S42) may be selected as receiving elements contributing to the image signal receiving process. Alternatively, receiving elements located at a central area of the region 23 may be selected as receiving elements contributing to the image signal receiving process. Alternatively, receiving elements contributing to the image signal receiving process may be selected based on the order of receiving intensity among receiving elements within the region 23.

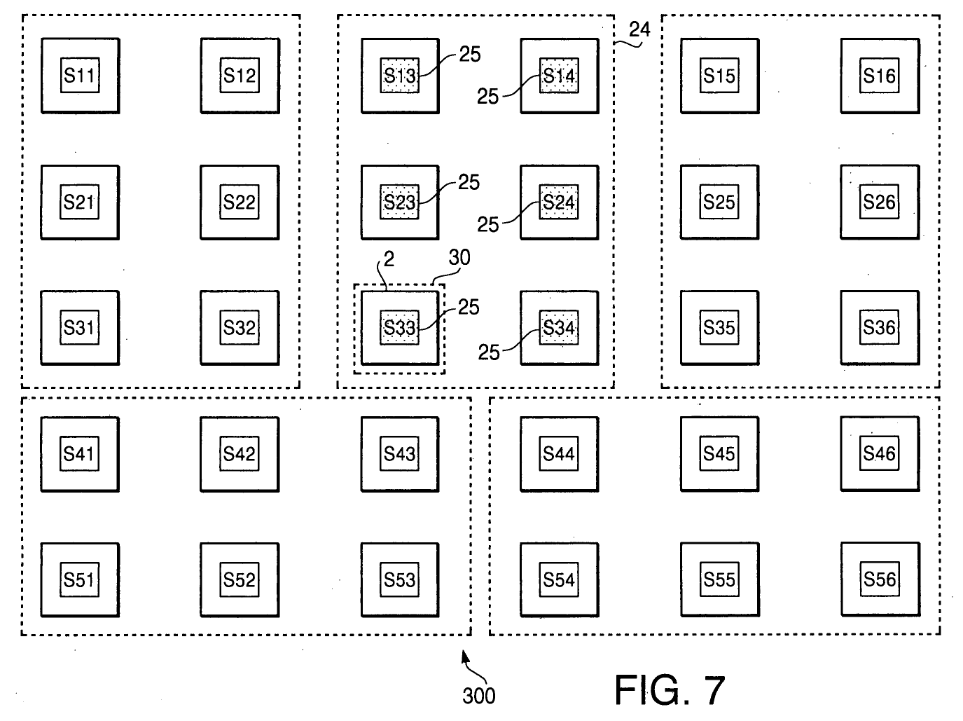

Next, another selection rule used in the selection process in step ST2 is explained with reference to FIG. 7. FIG. 7 is an explanatory diagram illustrating an example of a selection rule. As shown in FIG. 7, a plurality of receiving elements S (S1, S2, . . . , S56) are arranged in a matrix in the 2D-DST circuit 300. In this example, the receiving elements S (S1, S2, . . . , S56) are grouped into a plurality of blocks. In FIG. 7, a block 24 surrounded by a dashed line represents one of the groups. Each group includes a plurality of receiving elements. Although in FIG. 7 the number of receiving elements in the groups is the same, the groups may be configured to have different number of receiving elements. The 2D-DST circuit 300 may be configured such that a user can set the number of receiving elements in each group by operating the control unit 7 through use of, for example, the external personal computer (not shown).

In this example, after the receiving intensities of all of the receiving elements are collected by the control unit 7 (step ST1), an average of receiving intensities is calculated for each of the groups. Then, a group having the highest average of the receiving intensities is selected, and all of or a part of receiving elements in the selected group having the highest average are selected as receiving elements contributing to the image signal receiving process.

Alternatively, the group contributing to the image signal receiving process may be selected as follows. Firstly, at least one group of which minimum receiving intensity of all of the receiving elements belonging to the at least one group is larger than a certain level is selected. If a plurality of groups are selected in this stage, a group having the smallest intensity difference between the maximum intensity of all of receiving element belonging to the group and the minimum intensity of all of receiving elements belonging to the group is selected. Alternatively, a group of which deviation of intensities of all of receiving elements belonging to the group is smallest is selected. Then, all of or a part of receiving elements in the selected group is used as receiving elements contributing to the image signal receiving process.

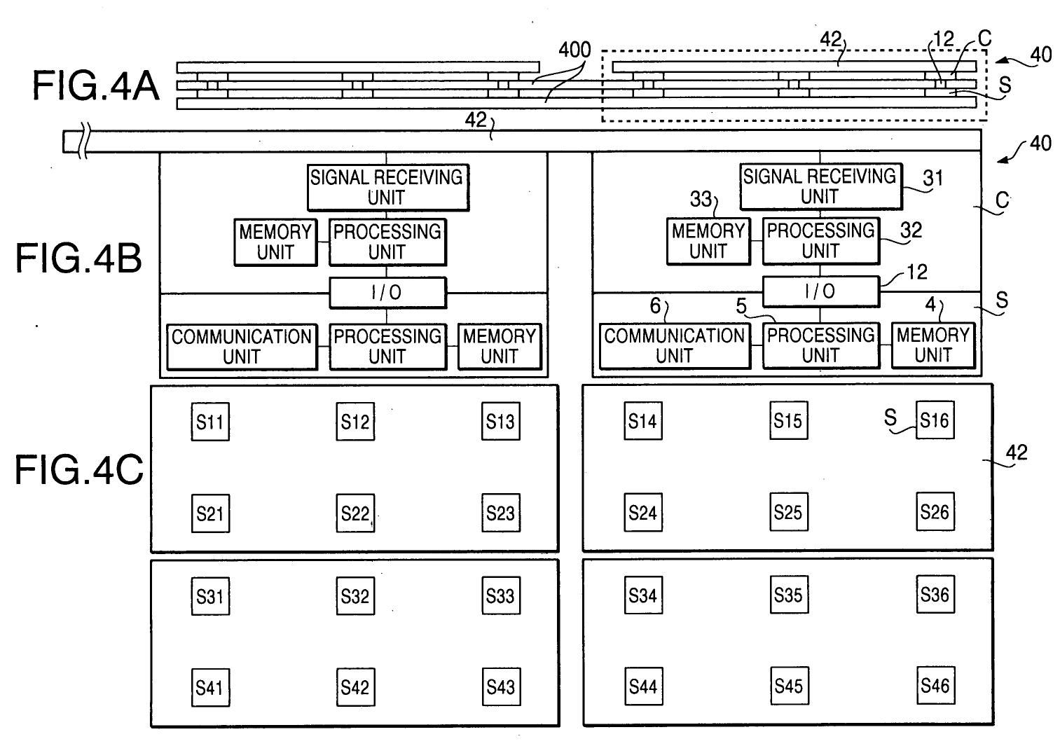

FIGS. 4A to 4C show another example of a configuration of a 2D-DST circuit. In this example, a relatively wide antenna 42 covering a plurality of receiving elements is employed. In FIGS. 4A to 4C, to components which are the same as those shown in FIG. 3, the same reference numbers are assigned, and the explanation thereof will not be repeated. FIG. 4A is a cross-sectional view of a 2D-DST circuit 400. As shown in FIG. 4A, an image signal receiving unit 40 includes the antenna 42, a plurality of sensor modules C and a plurality of receiving elements S. Each receiving element S includes an I/O unit 12 connecting the sensor module C to the receiving element S. The antenna 42 is connected to a plurality of sensor modules C which are connected to a plurality of receiving elements S, respectively.

FIG. 4B is a block diagram of the image signal receiving unit 40. As shown in FIG. 4B, the antenna 42 is connected to a plurality of signal receiving units 31 of the censor modules C.

FIG. 4C is a plan view of the 2D-DST circuit 400 shown in FIG. 4A. As shown in FIG. 4C, the antenna 42 covers a plurality of receiving elements S. In FIG. 4C, four signal receiving elements 40 are illustrated. Although in the example of FIG. 4C, the numbers of receiving elements connected to the antennas 42 are the same, the numbers of receiving elements connected to the antennas 42 may be different from each other.

In this example, one of image signal receiving units 40 (i.e. receiving elements S connected to one of antennas 42) is selected, and time-division multiplexing of the image signal receiving process is conducted by a plurality of receiving elements included in the selected image signal receiving unit 40.

Since in this example a size of the antenna is broad, reception sensitivity of an image signal can be enhanced.

Since in this example the image signal 8 is received by a single antenna 42 in the image signal receiving process, an image having relatively high consistency can be generated by the control unit 7. That is, the processed signals which are collected and combined by the control unit 7 to form an image are based on an image signal received by a single antenna 42. Therefore, a plurality of pieces of processed data 9 (divided image signals) obtained under a constant receiving level condition can be combined by the control unit 7. As a result, an image having relatively high consistency can be generated by the control unit 7.

By contrast, in the case of the configuration shown in FIGS. 3A to 3C, the plurality of pieces of processed data (divided image signals) collected by the control unit 7 are signals received under different receiving level conditions. Although the configuration shown in FIGS. 3A to 3C has a drawback with regard to a size of an antenna and a receiving intensity, the configuration shown in FIGS. 3A to 3C can provide an advantage regarding measuring resolution of the receiving intensity distribution, the degree of freedom and flexibility of an antenna arrangement.

Therefore, one of the configuration of FIGS. 3A to 3C and the configuration of FIGS. 4A to 4C may be selected in accordance with an application of the 2D-DST circuit.

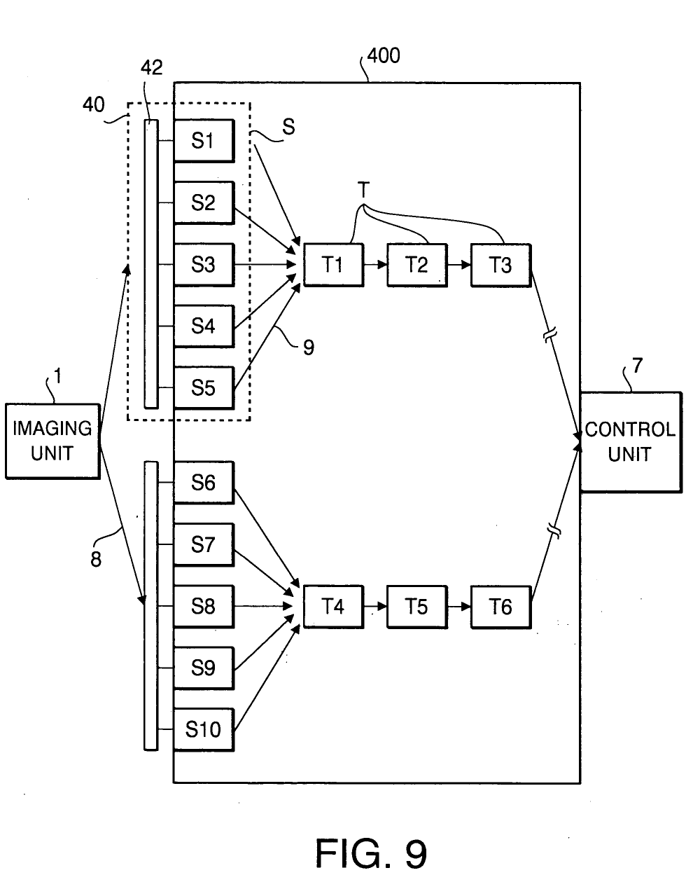

FIG. 9 is an explanatory diagram of the 2D-DST circuit 400 illustrating the image signal receiving process. In FIG. 9, to components which are the same as those shown in FIGS. 8 and 2, the same reference numbers are assigned, and the explanation thereof will not be repeated.

In the 2D-DST circuit 400, the reception setting process is conducted as follows. In this example, the receiving intensities of all of the antennas 42 are collected by the control unit 7 (step ST1 of FIG. 11). Then, an antenna having the highest receiving intensity is selected by the control unit 7, and all of or a part of receiving elements connected to the selected antenna 42 are selected as receiving elements contributing to the image signal receiving process (step ST2 of FIG. 11). After the relaying elements T, the communication path and the order of time-division multiplexing are determined in steps ST3, ST4 and ST5 of FIG. 11, time-division multiplexing of the image signal receiving process is conducted.

Alternatively, if a plurality of receiving antennas 42 have a receiving intensity larger than a certain level, one of the antennas 42 may be selected as an antenna contributing to the image signal receiving process. In FIG. 9, another image signal receiving unit including receiving elements S6, S7, S8, S9 and S10 is shown. If the image signal receiving unit having the receiving elements S6 to S10 is selected, the processed data 9 is transmitted to the control unit 7 via relaying elements T4, T5 and T6.

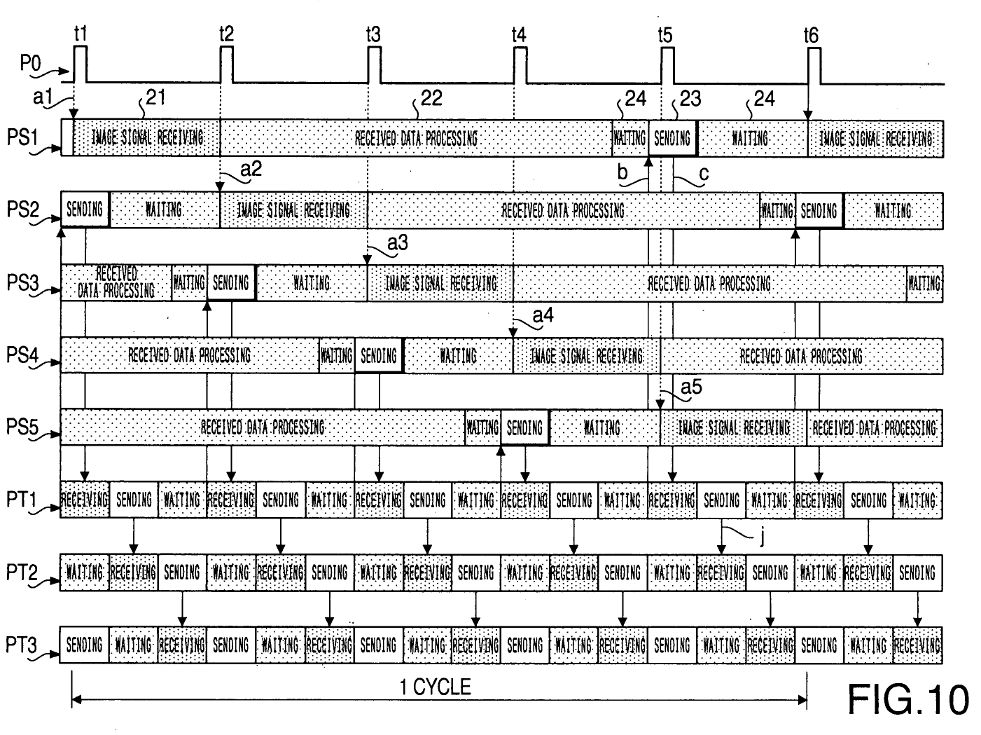

FIG. 10 is an example of a timing diagram illustrating one cycle of the time-division multiplexing of the image signal receiving process conducted by receiving elements S1 to S5 and the relaying elements T1, T2, T3 . . . . In the example shown in FIG. 10, five receiving elements S1 to S5 contribute to the image signal receiving process, and relaying elements T1 to T3 relay the processed data. Although in FIG. 10 only one cycle of the time-division multiplexing is illustrated, such a cycle is repeated sequentially. In one cycle, the image signal is received and processed by the receiving elements S1, S2, S3, S4 and S5 in this order. A plurality of pieces of processed data 9 outputted by the receiving elements S1 to S5 sequentially are firstly received by the relaying element T1 and then transmitted to the control unit 7 via relaying elements T2 and T3.

In FIG. 10, a reference number P0 represents a time chart of a synchronizing signal, reference numbers PS1, PS2, PS3, PS4 and PS5 represent time charts of the receiving elements S1, S2, S3, S4 and S5, respectively, and reference numbers PT1, PT2 and PT3 represent time charts of the relaying elements T1, T2 and T3, respectively. The time chart PS1 (i.e. the process of the receiving element S1) includes an image signal reception period 21 in which the processing unit 5 receives the image signal, a received data processing period 22 in which the processing unit 5 processes the received image signal, a data transmission period 23 in which the communication unit 6 sends the processed image signal to the relaying element T1 as the processed data 9, and waiting periods 24. The length of each image signal reception period 21 may be one of data transmission time required to transmit a frame of image signal, data transmission time required to transmit N frames of image signal (N: integer), data transmission time required to transmit a line of image signal, and data transmission time required to transmit N lines of image signal (N; integer).

More specifically, in the received data processing period 22, image data processing (e.g. conversion from a CCD image signal to a video signal and image data compression) is performed.

In the cycle of the image data receiving process, the receiving element S1 firstly receives the image signal (the image signal reception period 21). Then, the receiving element S1 processes the received image signal (the received data processing period 22). After waiting a certain time (waiting periods 24), the receiving element S1 transmits the processed data to the relaying element T1 (a data transmission period 23), and then waits a certain time (waiting periods 24). Such a sequence is performed by each of the receiving elements S1 to S5.

The synchronizing signal P0 is contained in a synchronization part of the image signal 8 generated by the capsule endoscope 10. As shown in FIG. 10, when the receiving elements S1, S2, S3 S4 and S5 respectively receive pulses t1, t2, t3, t4 and t5 on the synchronizing signal, the receiving elements S1, S2, S3 and S4 start to receive the image signal, as indicated by downward-pointing arrows a1, a2, a3, a4 and a5 in FIG. 10. An upward-pointing arrow “b” represents an enabling signal which is outputted by the relaying element T1 to allow the receiving element to send the processed data 9. If the receiving element S1 receives the enabling signal from the relaying element T1 (see an upward arrow “b”), the receiving elements S1 starts to send the processed data 9 to the relaying element T1 (see a downward-pointing arrow “c”).

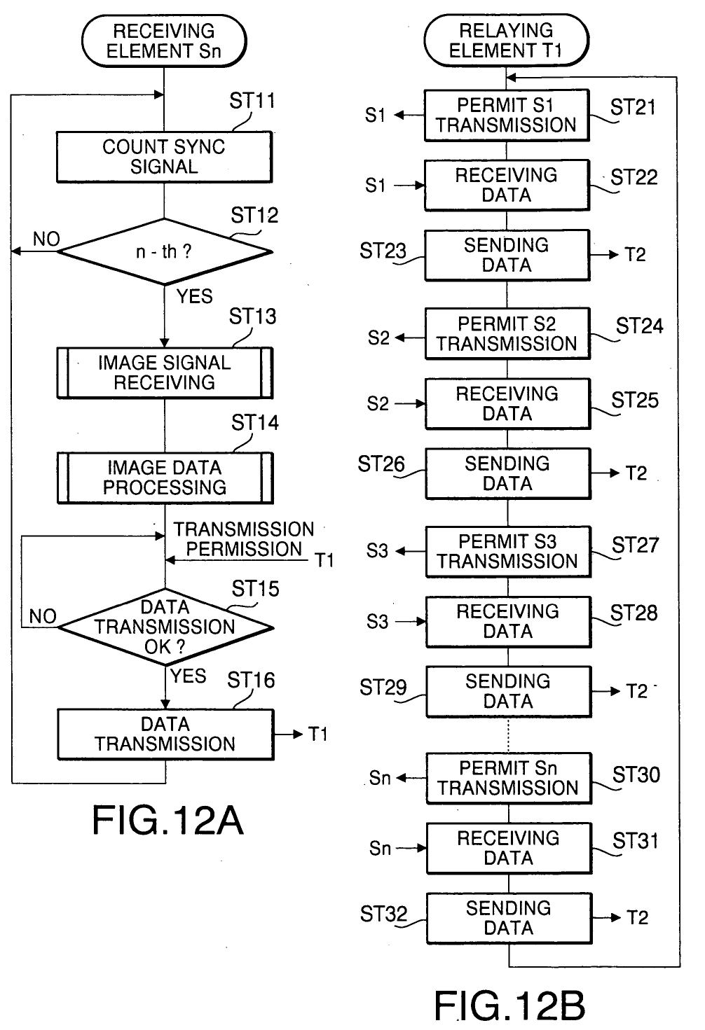

FIG. 12A is a flowchart illustrating one cycle of the image signal receiving process conducted by each of the receiving elements S1 to S5. FIG. 12B is a flowchart illustrating a relaying operation of the relaying element T1.

Firstly, the receiving element starts to count pulses on the synchronizing signal (step ST11). Then, the receiving element judges whether the count reaches a predetermined number. For example, if the receiving element S1 receives the pulse t1 (and a pulse t6 in a next cycle), the receiving element S1 determines that the count reaches the predetermined number (ST12: YES). Then, the receiving element S1 starts to receive the image signal (step ST13). If the count does not reach the predetermined number (ST12: NO), control returns to step ST11.

After the image signal reception period 21 is finished, the receiving element starts to process the received image signal (step ST14). After the received data processing period 22, the receiving element S1 goes to the waiting period 24 to wait the enabling signal indicating the permission of sending the processed data 9 (step ST15). More specifically, the enabling signal “b” is sent from the relaying element T1 to the receiving element S1 after the relaying element T1 receives the processed data 9 of the receiving element S5 and sends the processed data 9 of the receiving element S5 to the relaying element T2.

The waiting period continues until the receiving element receives the enabling signal (ST15: NO). If the receiving element receives the enabling signal outputted by the relaying element T1 (ST15: YES), the receiving element sends the processed data 9 to the relaying element T1 (step ST16). Then, control returns to step ST11 to go to a next cycle.

As shown in FIG. 12B, at step ST21, the relaying element T1 sends the enabling signal to the receiving element S1. Next, the relaying element T1 receives the processed data 9 outputted by the receiving element S1 (step ST22). Then, the receiving element T1 sends the processed data 9 to the relaying element T2 (step ST23).

In step ST24, the relaying element T1 sends the enabling signal to the receiving element S2. Next, the relaying element T1 receives the processed data 9 outputted by the receiving element S2 (step ST25). Then, the receiving element T1 sends the processed data 9 to the relaying element T2 (step ST26). Such a sequence is repeated (in steps ST27, ST28, ST29, ST30, ST31, ST32) until all of the processed data 9 outputted by the receiving elements S1 to S5 are sent to the relaying element T2. After the step ST32, control returns to step ST21 to restart the relaying operation.

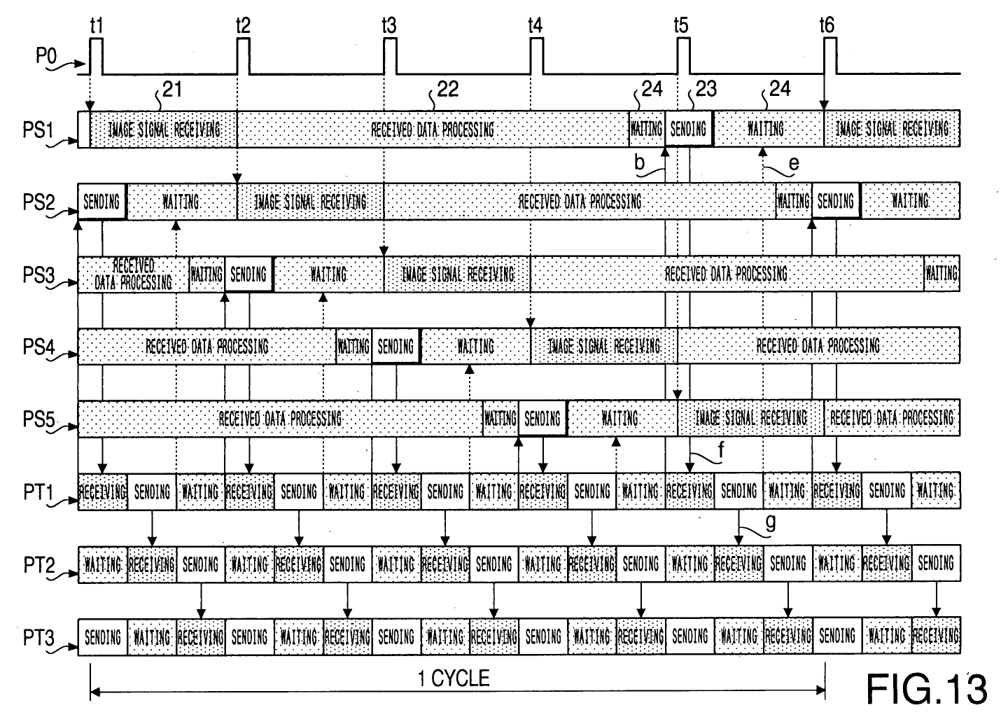

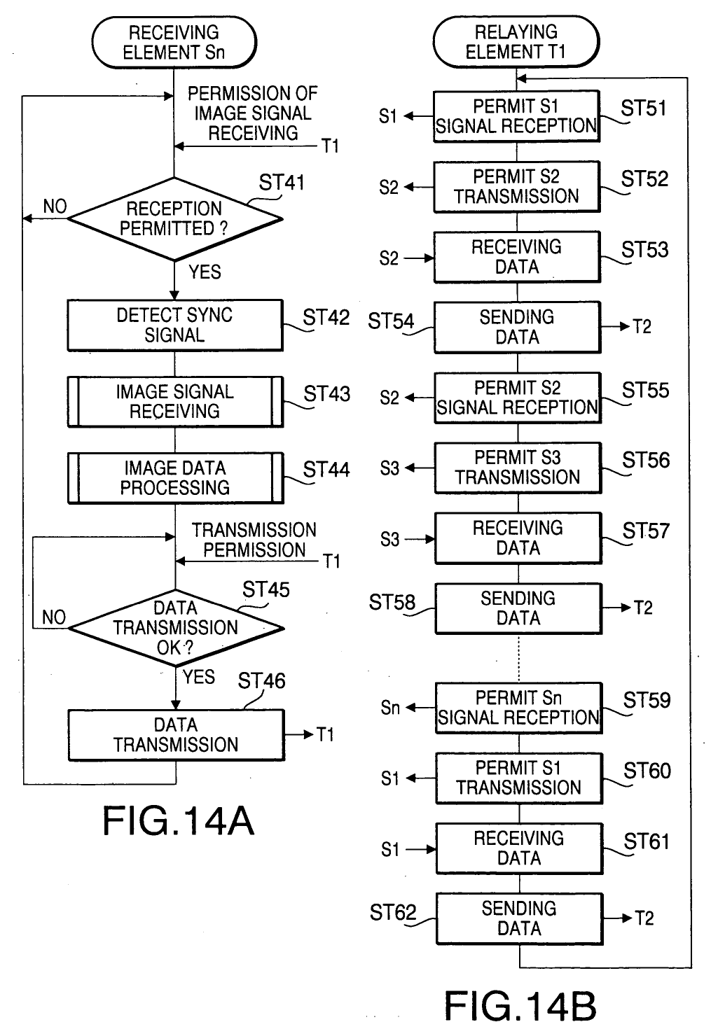

FIG. 13 is another example of a timing diagram illustrating one cycle of the time-division multiplexing of the image signal receiving process conducted by receiving elements S1 to S5 and the relaying elements T1, T2, T3 . . . . FIG. 14A is a flowchart illustrating one cycle of the image signal receiving process shown in FIG. 13 conducted by each of the receiving elements S1 to S5. FIG. 14B is a flowchart illustrating a relaying operation of the relaying element T1 with regard to the image signal receiving process shown in FIG. 13. In FIG. 13, to elements which are the same as those shown in FIG. 10, the same reference symbols are assigned, and the explanation thereof will not be repeated. In this example, permission of reception of the image signal is generated and sent by the relaying element T1.

In this example, at a first cycle, the receiving elements S1 to S5 start to receive the image signal when receiving the pulses t1 to t5, respectively. The receiving element S1 goes to the waiting period 24 after receiving a first part of the image signal, processing the image signal, and sending first processed data 9 to the relaying element T1 (see a downward-pointing arrow “f” in FIG. 13) so as to receive an enabling signal, which allows the receiving element S1 to receive a second part of the image signal, from the relaying element T1 (step ST41).

After the relaying element T1 receives the processed data 9 from the receiving element S1 and sends it to the relaying element T2 (see downward-pointing arrow “g” in FIG. 13), the relaying element T1 sends the enabling signal to the receiving element S1 (see upward-pointing arrow “e” in FIG. 13). The waiting period continues until the enabling signal is received (ST41: NO). If the receiving element S1 receives the enabling signal (ST41: YES), the receiving element S1 starts to detect a pulse on the image signal (i.e. a next pulse t6) in step ST42.

If the next pulse (t6) on the image signal is received, the receiving element S1 starts to receive a next part of the image signal. After the image signal reception period 21 is finished, the receiving element starts to process the received image signal (step ST44). After the received data processing period 22, the receiving element S1 goes to the waiting period 24 to wait an enabling signal (indicated by the upward-pointing arrow “b” in FIG. 13) indicating the permission of sending the processed data 9 (step ST45). More specifically, the enabling signal “b” is sent from the relaying element T1 to the receiving element S1 after the relaying element T1 receives the processed data 9 of the receiving element S5 and sends the processed data 9 of the receiving element S5 to the relaying element T2. The waiting period continues until the receiving element receives the enabling signal (ST45: NO). If the receiving element receives the enabling signal outputted by the relaying element T1 (ST45: YES), the receiving element sends the processed data 9 to the relaying element T1 (ST46). Then, control returns to step ST41 to go to a next cycle.

As shown in FIG. 14B, at step ST51, the relaying element T1 sends the enabling signal “e” indicating permission of reception of the image signal to the receiving element S1. Next, the relaying element T1 sends the enabling signal “b” indicating permission of transmission of the processed data to the receiving element S2 (step ST52). When the receiving element S2 receives the enabling signal “b”, the receiving element S2 sends the processed data 9 to the relaying element T1 (step ST53). Then, the relaying element T1 sends the processed data of the receiving element S2 to the relaying element T2 (step ST54).

Next, at step ST55, the relaying element T1 sends the enabling signal “e” indicating permission of reception of the image signal to the receiving element S2. Next, the relaying element T1 sends the enabling signal “b” indicating permission of transmission of the processed data to the receiving element S3 (step ST56). When the receiving element S3 receives the enabling signal “b”, the receiving element S3 sends the processed data 9 to the relaying element T1 (step ST57). Then, the relaying element T1 sends the processed data of the receiving element S3 to the relaying element T2 (step ST58). Such a sequence is repeated for each of the receiving elements S1 to S5 to complete the process of one cycle (steps ST59, ST60, ST61, and ST62).

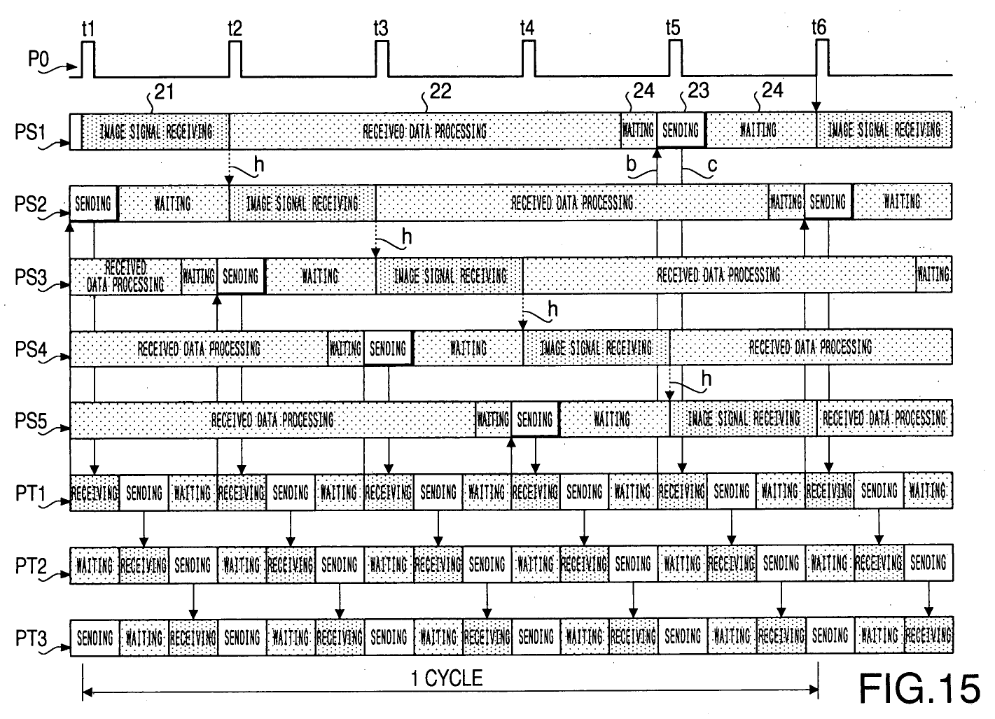

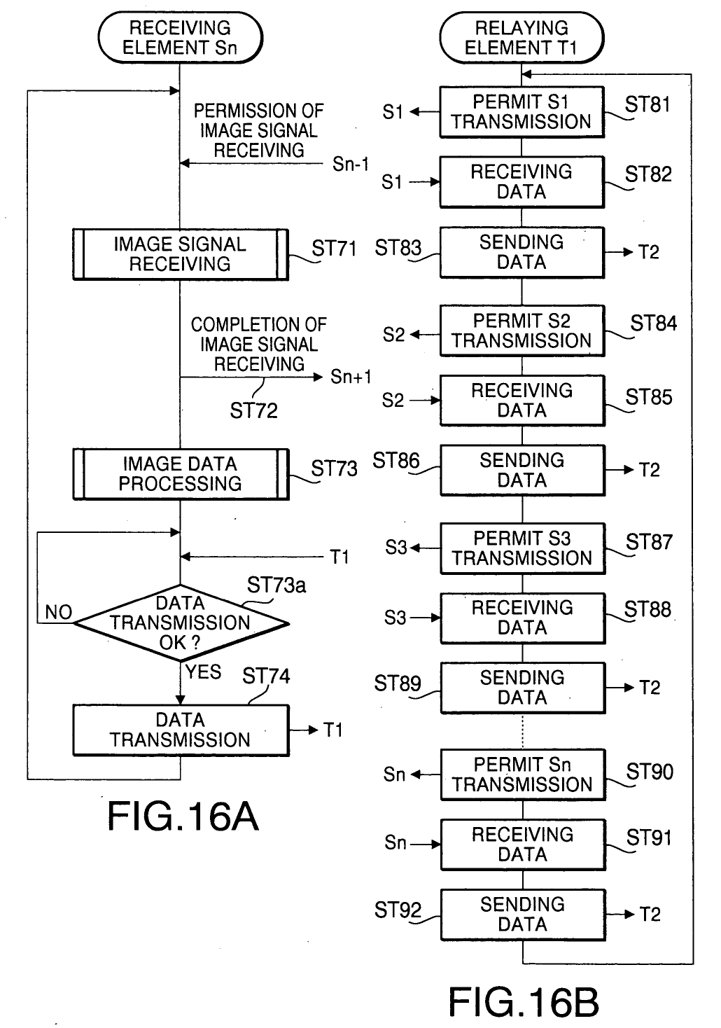

FIG. 15 is another example of a timing diagram illustrating one cycle of the time-division multiplexing of the image signal receiving process conducted by receiving elements S1 to S5 and the relaying elements T1, T2, T3 . . . . FIG. 16A is a flowchart illustrating one cycle of the image signal receiving process shown in FIG. 15 conducted by each of the receiving elements S1 to S5. FIG. 16B is a flowchart illustrating a relaying operation of the relaying element T1 with regard to the image signal receiving process shown in FIG. 15. In FIG. 15, to elements which are the same as those shown in FIG. 10, the same reference symbols are assigned, and the explanation thereof will not be repeated. In this example, permission of reception of the image signal is generated and sent by each receiving element S.

In FIG. 15, downward-pointing arrows “h” represent completion signals indicating completion of reception of the image signal. For example, the receiving element S1 sends a completion signal “h” to the receiving element S2 after completion of the image data reception period 21 of the receiving element S1.

As shown in FIG. 16A, the receiving element S1 starts to receive the image signal immediately after a first cycle is started (step ST71). After completion of the image signal reception period 21, the receiving element S1 sends a completion signal “h” to the receiving element S2 to allow the receiving element S2 to start the reception of the image signal (step ST72). If the receiving element S2 receives the completion signal “h” from the receiving element S1, the receiving element S2 goes to the image signal reception period 21 (step ST71).

Next, the receiving element S1 goes to the received data processing period 22 (step ST73). After completion of the received data processing period 22, the receiving element S1 goes to the waiting period 24 to wait the enabling signal “b” indicating the permission of sending the processed data 9 (step ST73a). The waiting period continues until the receiving element S1 receives the enabling signal (ST73a: NO). If the receiving element receives the enabling signal outputted by the relaying element T1 (ST73a: YES), the receiving element sends the processed data 9 to the relaying element T1 (step ST74). Then, control returns to step ST71 to go to a next cycle.

As shown in FIG. 16B, at step ST81, the relaying element T1 sends the enabling signal “b” to the receiving element S1. Next, the relaying element T1 receives the processed data 9 outputted by the receiving element S1 (step ST82). Then, the receiving element T1 sends the processed data 9 to the relaying element T2 (step ST83).

In step ST84, the relaying element T1 sends the enabling signal “b” to the receiving element S2. Next, the relaying element T1 receives the processed data 9 outputted by the receiving element S2 (step ST85). Then, the receiving element T1 sends the processed data 9 to the relaying element T2 (step ST86). Such a sequence is repeated (in steps ST87, ST88, ST89, ST90, ST91, and ST92) until all of the processed data 9 outputted by the receiving elements S1 to S5 is sent to the relaying element T2. After the step ST92, control returns to step ST81 to restart the relaying operation.

As described above, according to the embodiment of the invention, the image signal receiving process (including the image signal reception period 21, the received data processing period 22, the data transmission period 24) is conducted by time-division multiplexing. Therefore, a burden on each 2D-DST element is reduced, and thereby it becomes possible to configure the 2D-DST circuit using a small-sized and inexpensive receiving element.

Although the present invention has been described in considerable detail with reference to certain preferred embodiments thereof, other embodiments are possible.

For example, in the 2D-DST circuit 300 or the 2D-DST circuit 400, all of the 2D-DST elements 100 may be configured to have the function of receiving the image signal (i.e. to have the function as the image signal receiving unit 30). In this case, a part of 2D-DST elements 100 not contributing to the image signal receiving process functions as relaying elements.

The 2D-DST circuit 300 (400) may be formed to be worn (e.g. a jacket, a belly band, and a wrist band) by a subject to be subjected to a capsule endoscope examination. In this case, the capsule endoscope transmits an image signal from the inside of the subject's body while moving within the subject's body. If the wear of the subject is formed as the 2D-DST circuit 300 (400), an image of the inside of the subject's body is generated by the 2D-DST circuit 300 (400) and is displayed, for example, on an external monitor connected to the 2D-DST circuit 300 (400).

The image signal transmitted from the capsule endoscope to the receiving element may be performed by an ultrasonic wave or light.

The present disclosure relates to the subject matter contained in Japanese Patent Application No. P2004-063650, filed on Mar. 8, 2004, which is expressly incorporated herein by reference in its entirety.

1. An image signal processing device for processing an image signal transmitted from an imaging unit by radio, comprising:
at least one antenna that receives the image signal transmitted from the imaging unit by radio;
a substrate; and
a plurality of 2D-DST elements arranged on the substrate,
wherein:
the plurality of 2D-DST elements include a plurality of receiving elements each of which includes a processing unit having functions of receiving the image signal and processing the received image signal, the plurality of receiving elements being connected to the at least one antenna, and
at least a part of the plurality of receiving elements contributes to time-division multiplexing of receiving the image signal and processing the image signal.

2. The image signal processing device according to claim 1, wherein the plurality of 2D-DST elements include a plurality of relaying elements each of which has a function of relaying data processed by the at least a part of the plurality of receiving elements.

3. The image signal processing device according to claim 1, further comprising a control unit capable of receiving data from all of the plurality of 2D-DST elements to measure intensity distribution of intensities of the image signal received by the plurality of the receiving elements,
wherein the at least a part of the plurality of receiving elements contributing to the time-division multiplexing is selected by the control unit from the plurality of receiving elements based on the intensity distribution.

4. The image signal processing device according to claim 3, wherein:
the at least one antenna includes a plurality of antennas; and
the plurality of antennas are connected to the plurality of receiving elements, respectively.

5. The image signal processing device according to claim 4,
wherein the at least a part of the plurality of receiving elements selected by the control unit includes a first receiving element having a highest receiving intensity of the image signal, and at least one second receiving element surrounding the first receiving element.

6. The image signal processing device according to claim 4,
wherein the at least a part of the plurality of receiving elements selected by the control unit includes a first receiving element having a highest receiving intensity of the image signal, and at least one second receiving element capable of directly communicating with the first receiving element.

7. The image signal processing device according to claim 4,
wherein the at least a part of the plurality of receiving elements selected by the control unit includes at least two receiving elements having receiving intensities of the image signal larger than a predetermined level.

8. The image signal processing device according to claim 4, wherein:
the control unit divides the plurality of receiving elements into a plurality of groups and selects one of the plurality of groups having a highest average receiving intensity of all of the plurality of groups; and
the at least a part of the plurality of receiving elements contributing to the time-division includes receiving elements belonging to the selected one of the plurality of groups.

9. The image signal processing device according to claim 4, wherein:
the control unit divides the plurality of receiving elements into a plurality of groups and selects first groups from the plurality of groups, receiving intensities of receiving elements belonging to the first groups are larger than a predetermined level;
the control unit further selects one of the first groups having a smallest intensity variation of all of the first group; and
the at least a part of the plurality of receiving elements contributing to the time-division includes receiving elements belonging to the selected one of the first groups.

10. The image signal processing device according to claim 3, wherein:
the at least one antenna includes a plurality of antennas; and
each of the plurality of antennas is connected to two or more of the plurality of receiving elements.

11. The image signal processing device according to claim 10,
wherein the at least a part of the plurality of receiving elements contributing to the time-division includes receiving elements connected to one of the plurality of antennas having a highest receiving intensity.

12. The image signal processing device according to claim 10,
wherein the at least a part of the plurality of receiving elements contributing to the time-division includes receiving elements connected to one of the plurality of antennas having a receiving intensity larger than a predetermined level.

13. The image signal processing device according to claim 2, wherein:
each of the plurality of receiving elements includes a communication unit having a function of sending processed data processed by the processing unit to one of the plurality of relaying elements; and
the time-division multiplexing conducted by the at least a part of the plurality of receiving elements further includes sending the processed data to one of the plurality of relaying elements.

14. The image signal processing device according to claim 13,
wherein the at least a part of the plurality of receiving elements contributing to the time-division multiplexing performs the receiving of the image signal, the processing of the image signal, and the sending of the processed data in this order.

15. The image signal processing device according to claim 1, wherein:
the image signal transmitted by the imaging unit includes synchronizing signals; and
the time-division multiplexing of receiving the image signal and processing the image signal is conducted in synchronization with the synchronizing signals included in the image signal.

16. The image signal processing device according to claim 15,
wherein the at least a part of the plurality of receiving elements contributing to the time-division multiplexing counts the synchronizing signals included in the image signal to start the receiving of the image signal based on a count of the synchronizing signals.

17. The image signal processing device according to claim 15, wherein:
the plurality of 2D-DST elements include a plurality of relaying elements each of which has a function of relaying data processed by the at least a part of the plurality of receiving elements;
one of the plurality of relaying elements generates an enabling signal indicating permission of reception of the image signal; and
the at least a part of the plurality of receiving elements contributing to the time-division multiplexing starts the receiving of the image signal based on the enabling signal generated by the one of the plurality of relaying elements.

18. The image signal processing device according to claim 15, wherein:
the at least a part of the plurality of receiving elements contributing to the time-division multiplexing includes two or more receiving elements;
a first receiving element of the two or more receiving elements contributing to the time-division multiplexing outputs a completion signal after finishing the receiving of the image signal; and
a second receiving element of the two or more receiving elements contributing to the time-division multiplexing starts the receiving of the image signal based on the completion signal outputted by the first receiving element.

19. The image signal processing device according to claim 18,
wherein the first receiving element is capable of directly communicating with the second receiving element.

20. An image signal processing device, comprising:
a capsule endoscope having an imaging unit which captures an image and transmits an image signal of the image by radio;
at least one antenna that receives the image signal transmitted from the imaging unit;
a substrate; and
a plurality of 2D-DST elements arranged on the substrate,
wherein the plurality of 2D-DST elements include a plurality of receiving elements each of which includes a processing unit having functions of receiving the image signal and processing the received image signal, the plurality of receiving elements being connected to the at least one antenna, and
wherein at least a part of the plurality of receiving elements contributes to time-division multiplexing of receiving the image signal and processing the image signal.
